(19) United States
(12) Patent Application Publication
(10) Pub. No.: US 2020/0241721 A1
(43) Pub. Date: Jul. 30, 2020

(54) INTERACTIVE DISPLAY APPARATUS AND METHOD

(71) Applicant: SHENZHEN VISTANDARD DIGITAL TECHNOLOGY CO., LTD., Shenzhen (CN)

(72) Inventors: Dashuo Li, Shenzhen (CN); Guojun Zhang, Shenzhen (CN); Boxiang Pei, Shenzhen (CN); Zhuangxin Shen, Shenzhen (CN)

(73) Assignee: SHENZHEN VISTANDARD DIGITAL TECHNOLOGY CO., LTD., Shenzhen (CN)

(21) Appl. No.: 16/377,698

(22) Filed: Apr. 8, 2019

(30) Foreign Application Priority Data
Jan. 16, 2019 (CN) 201910038343.X

(51) Int. Cl. G06F 3/041; G06F 3/044; G06F 3/046; G06F 3/0354; G06F 3/03; G06F 3/01; H04N 13/359

(52) U.S. Cl. CPC G06F 3/04162; G06F 3/044; G06F 3/046; G06F 2203/04106; G06F 3/0304; G06F 3/012; H04N 13/359; G06F 3/03545

(57) ABSTRACT

Disclosed are interactive display apparatus and method. The apparatus comprises a host; a display screen and a touch console both connected to the host, the touch console comprising an electromagnetic capacitive double-touch display screen; and an interactive identification module which is configured for placing on the touch console to enable the host to acquire a position and an angle of the interactive identification module. The method comprises the following steps of: acquiring the position and the angle of the interactive identification module, and a touch instruction input to the touch console; and controlling a scene picture on the display screen according to the position and the angle of the interactive identification module and the touch instruction.

This application claims priority to a Chinese application number 201910038343.X filed on Jan. 16, 2019 and which is incorporated herein in its entirety by reference.

### FIELD

The present disclosure relates to the field of human-computer interaction, and in particular, to an interactive display apparatus and method.

### BACKGROUND

With the development of network technologies, people have increasingly higher requirements for human-computer interaction experience. Referring to Chinese invention patent CN 105139784 A, on the interactive platform in the prior art, a projector is generally used to project a navigation interface on a transparent or semi-transparent interactive platform screen, and an infrared camera is used to collect information such as types, positions and angles of identification tags on an interactive image identification module on the interactive platform, and then a rendered scene is displayed on the display screen.

A scene display apparatus in the prior art has following problems. Firstly, the height of the interactive platform is limited by the projection range, angle and distance of the projector. For example, the height of the interactive platform needs to be set relatively high (generally 1 m) to adapt to the projection distance, which is not conducive to the miniaturization design of the scene display apparatus.

Secondly, when used for projection display the projector is slow to switch on and off and needs to be preheated. Moreover, the picture projected and displayed is not clear and requires installation and debugging of a light path (the projection is aimed at the screen for focusing). Thus, assembling is difficult.

Thirdly, the camera lens is consumable and easy to damage, and has high maintenance costs.

Fourthly, scene displaying through the identification tags on the interactive image identification module needs, in addition to a camera, a fill light to supplement infrared lights to improve the identification degree, thus increasing the cost.

Besides, in the prior art, some interactive platforms use contacts of a capacitive touch screen for human-computer interaction, and the capacitive contacts on the interactive identification module has the problem of poor contact which is more likely to happen during movement, thus leading to system instability.

### SUMMARY

The present disclosure is aimed at solving, at least to some extent, one of the technical problems in the related arts. To this end, an objective of the present disclosure is to provide an interactive display apparatus with high stability and portability.

To this end, a second objective of the present disclosure is to provide an interactive display method that is convenient to operate and has good user experience.

According to one aspect of the disclosure, an interactive display apparatus is provided, comprising:

a host;

a display screen and a touch console both connected to the host, the touch console comprising an electromagnetic capacitive double-touch display screen; and

an interactive identification module which is configured for placing on the touch console to enable the host to acquire a position and an angle of the interactive identification module.

In some embodiments, the apparatus further comprises:

an interactive device; and

a motion capture device connected to the host and configured to capture a head position of a user and a position of the interactive device.

In some embodiments, the interactive device is an electromagnetic pen.

In some embodiments, the motion capture device comprises an optical camera.

In some embodiments, the display screen is a glasses-free 3D display screen.

In some embodiments, the glasses-free 3D display screen is a glasses-free 3D display screen with a one-key 2D/3D switching function.

In some embodiments, the interactive identification module comprises at least two contacts through which the host acquires the position and the angle of the interactive identification module.

According to another aspect of the disclosure, an interactive display method, applied to an interactive display apparatus, is provided,

the interactive display apparatus comprises:
a host;
a display screen and a touch console both connected to the host, the touch console comprising an electromagnetic capacitive double-touch display screen; and
an interactive identification module which is configured for placing on the touch console to enable the host to acquire a position and an angle of the interactive identification module;

the method comprises the following steps of:
acquiring the position and the angle of the interactive identification module, and a touch instruction input to the touch console; and
controlling a scene picture on the display screen according to the position and the angle of the interactive identification module and the touch instruction.

In some embodiments, the interactive display apparatus further comprises:

an interactive device; and

a motion capture device connected to the host and configured to capture a head position of a user and a position of the interactive device.

In some embodiments, the method further comprises steps of:

acquiring a position of the interactive device; and

controlling the scene picture on the display screen according to the position of the interactive device.

In some embodiments, the method further comprises steps of:

acquiring a head position of a user; and

controlling the scene picture on the display screen according to the head position of the user.

In some embodiments, the interactive device is an electromagnetic pen.

In some embodiments, the motion capture device comprises an optical camera.

In some embodiments, the display screen is a glasses-free 3D display screen.

In some embodiments, the glasses-free 3D display screen is a glasses-free 3D display screen with a one-key 2D/3D switching function.

Beneficial effects of the present disclosure are as follows. In the present disclosure, a display screen, a touch console, an interactive identification module and a host are provided, the touch console includes an electromagnetic capacitive double-touch display screen, the interactive identification module is placed on the touch console, the display screen is controlled to display a scene picture by acquiring the position and the angle of the interactive identification module, and the use of the electromagnetic capacitive double-touch display screen overcomes the problem of poor contact between a capacitive screen and an interactive identification module in the prior art, thus providing a more stable interactive display apparatus and method with better user experience. Moreover, the apparatus is highly integrated and easy to carry, and has a low cost and good economic and social benefits.

The interactive display apparatus and method according to the present disclosure can be widely applied to a variety of scene display apparatuses for human-computer interaction.

### BRIEF DESCRIPTION OF THE DRAWINGS

FIG. 1 is a schematic structural diagram of an embodiment of an interactive display device according to the present disclosure.

FIG. 2a and FIG. 2b are schematic structural diagrams of an embodiment of an interactive identification module according to the present disclosure.

### DETAILED DESCRIPTION OF THE EMBODIMENTS

It should be noted that embodiments and features in the embodiments of the specification may be combined with each other without conflicts.

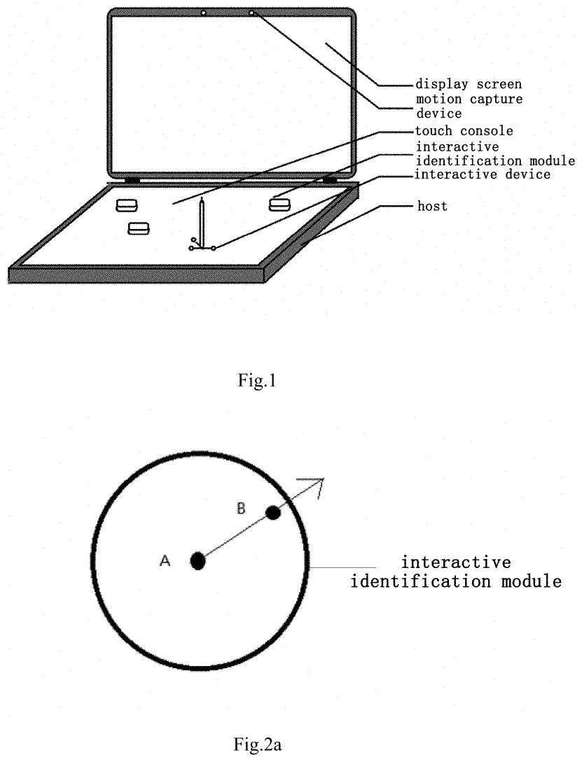

An interactive display apparatus is provided in the present disclosure, which, as shown in FIG. 1, includes a display screen, a touch console, an interactive identification module and a host. The display screen and the touch console are both connected to the host, the touch console includes an electromagnetic capacitive double-touch display screen, and the interactive identification module is placed on the touch console to enable the host to acquire a position and an angle of the interactive identification module. In this embodiment, the interactive identification module is a module with defined interaction functions, such as a first-person view interactive module. When the first-person view interactive module is placed on the touch console, a first-person view scene picture will be rendered on the display screen.

As an improvement to the technical solution, the interactive display apparatus further includes an interactive device which is connected to the host. In this embodiment, the interactive device may be an electromagnetic pen or other hand operating devices with touch and glasses-free 3D display functions. The function of the electromagnetic pen is to write on the touch console, such as menu selection, clicking and dragging.

Besides, the interactive display apparatus further includes a motion capture device. Multiple reflective balls are provided at the end of the electromagnetic pen. When the electromagnetic pen performs 3D operations on the picture displayed on the screen in the air, the motion capture device can capture positions of the multiple reflective balls so as to acquire the spatial position of the electromagnetic pen, and can implement operations such as clicking, dragging, rotating and capture in cooperation with buttons on the electromagnetic pen.

The motion capture device is connected to the host and is further configured to capture a head position of a user and send it to the host which controls a scene picture on the display screen according to the head position of the user. In order to improve the precision and accuracy of capture, multiple motion capture cameras can be provided, which capture the head position of the user at the same time. The host measures a spatial position of the head of the user (mainly the distance between the head position of the user and the display screen and an angle of deviation from the midline of the display screen) according to the captured head position of the user, and then the scene picture on the display screen is adjusted correspondingly so as to implement human-computer interaction.

In this embodiment, the motion capture device includes an optical motion capture camera which may be provided on an upper part of the display screen. The optical motion capture camera collects the head position of the user and the position of the interactive device using an infrared technology. Generally, two optical motion capture cameras are used as a group and set as a motion capture device, or more than two optical motion capture cameras may be used as a group.

In this embodiment, the display screen is a glasses-free 3D screen, which can implement one-key 2D/3D mode switching. A switch key is provided on the display screen. Users can switch modes through the key as required to make a picture of the display screen become a 2D or 3D picture.

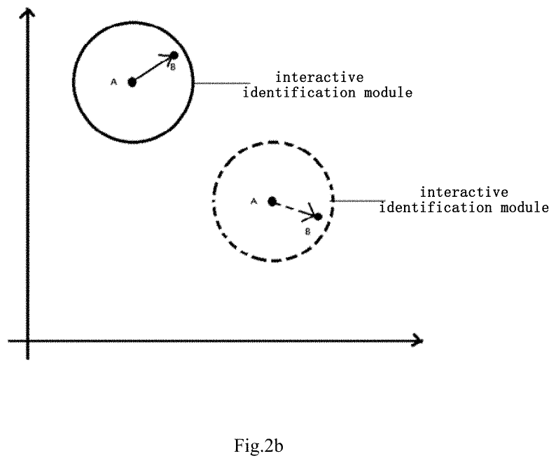

FIG. 2a and FIG. 2b are schematic structural diagrams of an embodiment of contact identification on an interactive identification module according to the present disclosure. The interactive identification module includes at least two contacts, for example two in this embodiment, one is Contact A, and the other is Contact B, as shown in FIG. 2a. Preferably, the Contact A is provided in a center position of the interactive identification module, and the Contact B is provided in another position. When the interactive identification module is placed on the touch console, the touch console acquires the position of the interactive identification module on the touch console by acquiring the position of the Contact A, and acquires an angle between the interactive identification module and the touch console by acquiring the positions of the Contact A and the Contact B. As shown in FIG. 2b, when moving the interactive identification module, the Contact A and the Contact B move together with the interactive identification module. The touch console acquires the moving position and angle of the interactive identification module by acquiring moving positions of the Contact A and the Contact B. The host controls the picture displayed on the display screen to correspondingly move and change the angle according to the moving position and angle of the interactive identification module.

In this embodiment, the touch console includes an electromagnetic capacitive double-touch display screen. When only a single interactive identification module N is placed on the touch console, both the Contact A and the Contact B may be electromagnetic contacts; or the Contact A is an electromagnetic contact, and the Contact B is a capacitive contact. When multiple interactive identification modules N1, N2, . . . , Nn (the interactive identification module N1 includes Contact A1 and Contact B1, the interactive identification module N2 includes Contact A2 and Contact B2, . . . , and the interactive identification module Nn includes Contact An and Contact Bn) are placed on the touch console, the contacts A1 to An are electromagnetic contacts (electromagnetic frequencies of the contacts A1 to An are different, so that the touch console can sense multiple interactive identification modules at the same time), and the contacts B1 to Bn are capacitive contacts. Since the electromagnetic contacts are induced by electromagnetic signals, they can be sensed and recognized when they are close to the touch console without touching the screen. The provision of the electromagnetic contacts effectively solves the problem of poor contact between the capacitive contacts and the touch console, thus making the system more stable. In addition, placing multiple interactive identification modules can meet the requirements of complex interaction scenes, and multiple objects and parameters in the scene picture can be simultaneously operated and controlled.

An interactive display method is further disclosed in the present disclosure, which is applied to the interactive display apparatus as described above, and includes the following steps of: acquiring a position and an angle of an interactive identification module, and a touch instruction input to a touch console; and controlling a scene picture on the display screen according to the position and the angle of the interactive identification module and the touch instruction.

Specifically, after startup, a menu navigation interface will be displayed on the touch console, and a defaulted scene picture will be displayed on the display screen. After the interactive identification module is placed on the touch console, the touch console identifies contacts A and B, and renders a scene picture of a corresponding view on the display screen according to the positions of the contacts A and B. In addition, a user can also use an interactive device or directly click the menu navigation interface on the touch console to send a touch instruction to the host, such as clicking and dragging. After receiving the touch instruction, the host controls the picture on the display screen to change accordingly. When the interactive identification module is moved and rotated, the positions of the contacts A and B of the interactive identification module change accordingly, and the host acquires position variation parameters of the contacts A and B and controls the picture on the display screen to change accordingly.

After other interactive identification modules are placed continuously, the host acquires contacts of all the interactive identification modules, processes contact groups (A1, B1; A2, B2; A3, B3; A4, B4; . . . ), and controls the display screen to display corresponding scene effects. For example, three interactive identification modules are placed, and the display screen can be controlled to display different scene pictures through different contact groups:

Scene picture 1: contact A1+contact B1;
Scene picture 2: contact A2+contact B2; and
Scene picture 3: contact A3+contact B3.

As an improvement to the technical solution, the interactive display method further includes steps of:

acquiring a position of the interactive device; and

controlling the scene picture on the display screen according to the position of the interactive device.

Specifically, since the interactive device has a glasses-free 3D display function, it can perform 3D operations on the scene picture on the display screen spatially. The motion capture device captures a position of the interactive device and sends it to the host, and the host controls the display screen to display the corresponding scene picture according to the position of the interactive device.

According to a scene actually needing to be rendered, the host can only acquire position changes in the interactive identification module to control the scene picture on the display screen, or can only acquire a spatial position of the interactive device to control the scene picture on the display screen, or can also acquire position changes in the interactive identification module and a spatial position of the interactive device at the same time to jointly control the scene picture on the display screen according to position changes produced by moving the interactive identification module and position changes in the interactive device. For example, if the scene picture displayed on the display screen is a house, a position of viewing the housing can be selected by moving the interactive identification module, and a viewing angle can be rotated by rotating the interactive device.

As an improvement to the technical solution, the interactive display method further includes steps of:

acquiring a head position of a user; and

controlling the scene picture on the display screen according to the head position of the user.

In addition to acquiring the position of the interactive device, the host also acquires a head position (or an eye position) of a user through the motion capture device to adjust the scene picture on the display screen. For example, when the head of the user deviates from the motion capture device, the scene on the display screen deviates accordingly.

Preferred embodiments of the present disclosure are specifically described above, but the present disclosure is not limited thereto. Those skilled in the art can make various equivalent variations or replacements without departing from the principle of the present disclosure, and these variations or replacements are all included in the scope defined by the claims of the application.

1. An interactive display apparatus, comprising:
a host;
a display screen and a touch console both connected to the host, the touch console comprising an electromagnetic capacitive double-touch display screen; and
an interactive identification module which is configured for placing on the touch console to enable the host to acquire a position and an angle of the interactive identification module.

2. The interactive display apparatus of claim 1, further comprising:
an interactive device; and
a motion capture device connected to the host and configured to capture a head position of a user and a position of the interactive device.

3. The interactive display apparatus of claim 2, wherein the interactive device is an electromagnetic pen.

4. The interactive display apparatus of claim 2, wherein the motion capture device comprises an optical camera.

5. The interactive display apparatus of claim 1, wherein the display screen is a glasses-free 3D display screen.

6. The interactive display apparatus of claim 5, wherein the glasses-free 3D display screen is a glasses-free 3D display screen with a one-key 2D/3D switching function.

7. The interactive display apparatus of claim 1, wherein the interactive identification module comprises at least two contacts through which the host acquires the position and the angle of the interactive identification module.

8. An interactive display method, applied to an interactive display apparatus,
the interactive display apparatus comprising:
a host;
a display screen and a touch console both connected to the host, the touch console comprising an electromagnetic capacitive double-touch display screen; and
an interactive identification module which is configured for placing on the touch console to enable the host to acquire a position and an angle of the interactive identification module;
the method comprising the steps of:
acquiring the position and the angle of the interactive identification module, and a touch instruction input to the touch console; and
controlling a scene picture on the display screen according to the position and the angle of the interactive identification module and the touch instruction.

9. The interactive display method of claim 8, the interactive display apparatus further comprising:
an interactive device; and
a motion capture device connected to the host and configured to capture a head position of a user and a position of the interactive device.

10. The interactive display method of claim 9, further comprising steps of:
acquiring a position of the interactive device; and
controlling the scene picture on the display screen according to the position of the interactive device.

11. The interactive display method of claim 9, further comprising steps of:
acquiring a head position of a user; and
controlling the scene picture on the display screen according to the head position of the user.

12. The interactive display method of claim 9, wherein the interactive device is an electromagnetic pen.

13. The interactive display method of claim 9, wherein the motion capture device comprises an optical camera.

14. The interactive display method of claim 8, wherein the display screen is a glasses-free 3D display screen.

15. The interactive display method of claim 14, wherein the glasses-free 3D display screen is a glasses-free 3D display screen with a one-key 2D/3D switching function.
